(19) United States
(12) Patent Application Publication
(10) Pub. No.: US 2014/0174953 A1
(43) Pub. Date: Jun. 26, 2014

(54) HAND-HELD TEST METER CONFIGURED FOR DISTINGUISHING ORIENTATION OF ANALYTICAL TEST STRIP INSERTION

(71) Applicant: CILAG GMBH INTERNATIONAL, Zug (CH)

(72) Inventors: David ELDER, Inverness (GB); Eric Bergman, Milpitas, CA (US); Allan Macrae, Inverness (GB); Steve Syme, Oxford (GB)

(73) Assignee: Cilag GmbH International, Zug (CH)

(21) Appl. No.: 13/725,107

(22) Filed: Dec. 21, 2012

(51) Int. Cl. G01N 27/28

(52) U.S. Cl. CPC G01N 27/28
USPC 205/782; 204/403.01

(57) ABSTRACT

A hand-held test meter for use with an analytical test strip (such as an electrochemical-based analytical test strip) in the determination of an analyte (e.g., glucose) in a bodily fluid sample (such as a whole blood sample) includes a housing, a display block, a micro-controller disposed in the housing, a strip detection circuit block disposed in the housing, and a strip port connector with a test strip insertion detector(s). The test strip insertion detector(s) and strip detection circuit block are configured to detect the insertion of an analytical test strip into the strip port connector and send an insertion signal to the micro-controller upon such detection. In addition, the micro-controller is configured to receive the insertion signal, distinguish an orientation of analytical test strip insertion based on at least the insertion signal and signal the display module to display a predetermined message to a user based on the distinguished orientation of analytical test strip insertion.

### BACKGROUND OF THE INVENTION

1. Field of the Invention

The present invention relates, in general, to medical devices and, in particular, to hand-held test meters and related methods.

2. Description of Related Art

The determination (e.g., detection and/or concentration measurement) of an analyte in, or a characteristic of, a fluid sample is of particular interest in the medical field. For example, it can be desirable to determine glucose, ketone bodies, cholesterol, lipoproteins, triglycerides, acetaminophen, hematocrit and/or HbA1c concentrations in a sample of a bodily fluid such as urine, blood, plasma or interstitial fluid. Such determinations can be achieved using an analytical test strip (such as an electrochemical-based analytical test strip) and an associated hand-held test meter.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, in which like numerals indicate like elements, of which:

FIG. 1 is a simplified perspective depiction of a hand-held test meter according to an embodiment of the present invention;

FIG. 2 is a block diagram of the hand-held test meter of FIG. 1;

FIG. 3 is a simplified cross-sectional side-view depiction of a strip port connector (including a test strip insertion detector) of the hand-held test meter of FIG. 1;

FIG. 4 is a simplified cross-sectional side-view depiction of the strip port connector (including the test strip insertion detector) of the hand-held test meter of FIG. 1 with an analytical test strip (TS) inserted therein;

FIG. 5 is a simplified top cross-sectional block and test strip insertion switch-schematic diagram representing an analytical test strip inserted with an incorrect orientation into the strip port connector of the hand-held test meter of FIG. 1;

FIG. 6 is a simplified top cross-sectional block and test strip insertion switch-schematic diagram representing an analytical test strip inserted with a correct orientation into the strip port connector of the hand-held test meter of FIG. 1 and with a line (EC) indicating electrical continuity through the analytical test strip;

FIG. 7 is a simplified top cross-sectional block and test strip insertion switch-schematic diagram representing an analytical test strip inserted with an incorrect orientation into the strip port connector of the test meter of FIG. 1 and with a line (ENC) indicating electrical non-continuity through the analytical test strip;

FIG. 8 is a flow diagram illustrating an example of operation of a hand-held test meter according to the present invention;

FIG. 9 is a simplified perspective depiction of an analytical test strip being inserted into a strip port connector;

FIG. 10 is a simplified perspective depiction of an analytical test strip being inserted, with a correct orientation, into a strip port connector with a plurality of test strip insertion detectors as can be included in another hand-held test meter according to embodiments of the present invention;

FIG. 11 is a simplified perspective depiction of an analytical test strip being inserted, with an incorrect orientation, into a strip port connector with a plurality of test strip insertion detectors as can be included in another hand-held test meter according to embodiments of the present invention;

FIGS. 12A and 12B are simplified perspective and end views of a strip port connector with a plurality of electro-mechanical strip insertion detectors that have dual electrical contacts as can be included in hand-held test meters according to embodiments of the present invention;

FIG. 13 is simplified perspective depiction of an analytical test strip being inserted, with a correct orientation, into the strip port connector of FIGS. 12A and 12B but only depicting the electrical contacts that would make electrical contact to the analytical test strip;

FIG. 14 is simplified perspective depiction of an analytical test strip being inserted, with a simple upside down orientation (i.e., an orientation that is rotated 180 degrees about the longitudinal axis of the analytical test strip in comparison to the orientation of FIG. 13), into the strip port of FIGS. 12A and 12B but only depicting the electrical contacts that would make electrical contact to the analytical test strip; and

FIG. 15 is a flow diagram depicting stages in a method for employing a hand-held test meter according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

In general, hand-held test meter combinations for use in the determination of an analyte (such as glucose) in a bodily fluid sample (e.g., a whole blood sample) and/or the determination of a characteristic (such as hematocrit) in a bodily fluid sample according to embodiments of the present invention include a housing, a display block, a micro-controller disposed in the housing, a strip detection circuit block disposed in the housing and a strip port connector with at least one test strip insertion detector. The at least one test strip insertion detector and strip detection circuit block are configured to detect the insertion of an analytical test strip into the strip port connector and send an insertion signal to the micro-controller upon such detection. In addition, the micro-controller is configured to receive the insertion signal, distinguish an orientation of analytical test strip insertion (for example, either a correct orientation or an incorrect orientation of analytical test strip insertion) based on at least the insertion signal and signal the display module to display a predetermined message to a user based on the distinguished orientation of analytical test strip insertion.

Hand-held test meters according to embodiments of the present invention are beneficial in that, for example, the hand-held test meters are easy and quick to use since the orientation of test strip insertion is detected and the user alerted accordingly and, alternatively, also instructed in remedying the incorrect insertion. For example, the predetermined message displayed by the display module can alert a user to an incorrect orientation of analytical test strip insertion and prompt the user to re-insert the analytical test strip using a correct orientation of analytical test strip insertion.

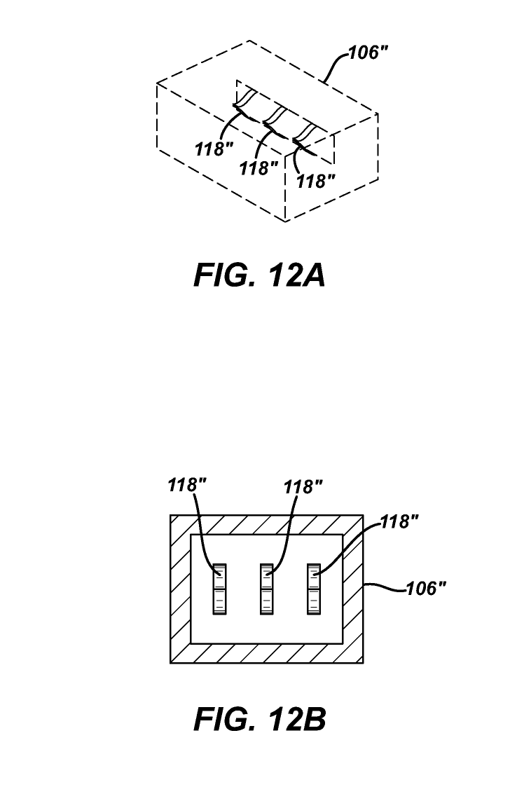

It should be noted that the terms “incorrect orientation” and “correct orientation” are context dependent since the correctness of any particular orientation is dependent on the configuration of an analytical test strip and its associated hand-held test meter. Analytical test strips are typically elongated in shape with two distinct ends, an upper surface and a lower surface. Moreover, one end of such an elongated analytical test strip is typically designed for insertion into a hand-held test meter with the upper surface of the analytical test strip facing upwards. Such a circumstance typically gives rise to four potential orientations of analytical test strip insertion, namely (i) a “correct” orientation wherein the end of the analytical test strip designed for insertion is indeed inserted and the upper surface is facing upward; (ii) an incorrect orientation wherein the wrong end of the analytical test strip is inserted but with the upper surface facing upward; (iii) an incorrect orientation wherein the wrong end of the analytical test strip is inserted with the upper surface facing downward and (iv) a usually incorrect orientation wherein the end of the analytical test strip designed for insertion is indeed inserted but the upper surface is facing downward. Both orientations (iii) and (iv) can be referred to as “upside down” orientations, while both orientations (ii) and (iii) can be referred to as “wrong end” first orientations. However, since hand-held test meters according to embodiments of the present invention (such as the embodiment depicted in FIGS. 12A-14) can accommodate orientation (iv), such an orientation is not necessarily an incorrect orientation and, therefore, is also referred to herein as a “simple” upside down orientation.

Once one skilled in the art is apprised of the present disclosure, he or she will recognize that an example of a hand-held test meter that can be readily modified as a hand-held test meter according to the present invention is the commercially available OneTouch® Verio® glucose meter from LifeScan, Inc. (Milpitas, Calif.). Additional examples of hand-held test meters that can also be modified are found in U.S. Patent Application Publications No's. 2007/0084734 (published on Apr. 19, 2007) and 2007/0087397 (published on Apr. 19, 2007) and in International Publication Number WO2010/049669 (published on May 6, 2010), each of which is hereby incorporated herein in full by reference.

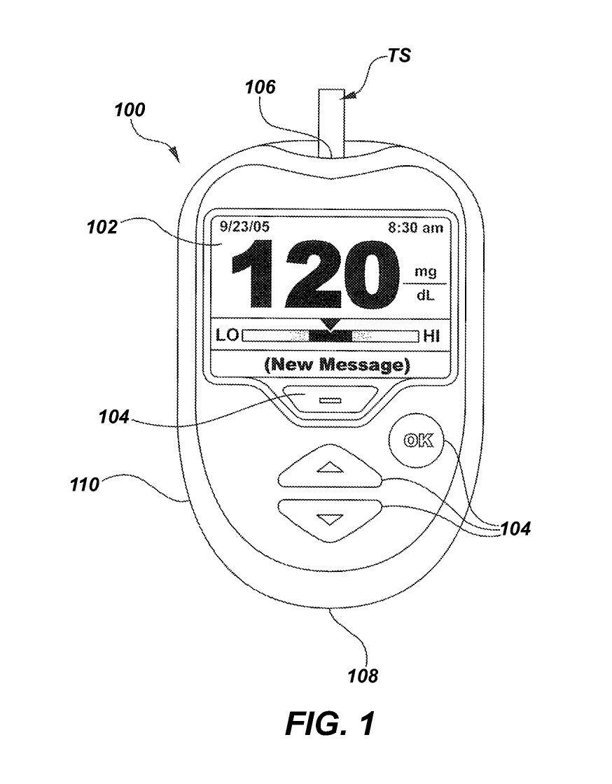

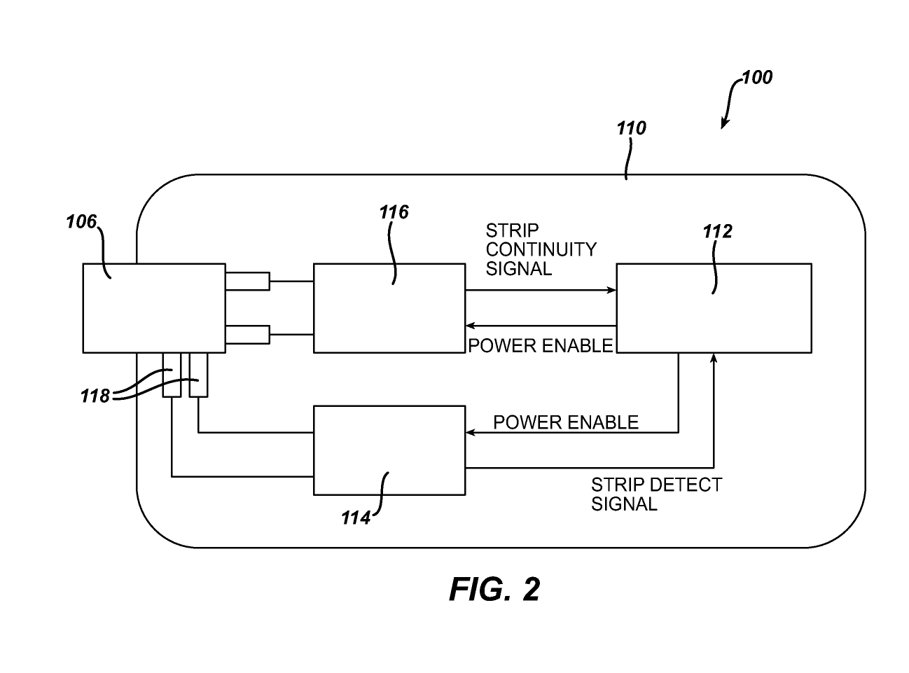

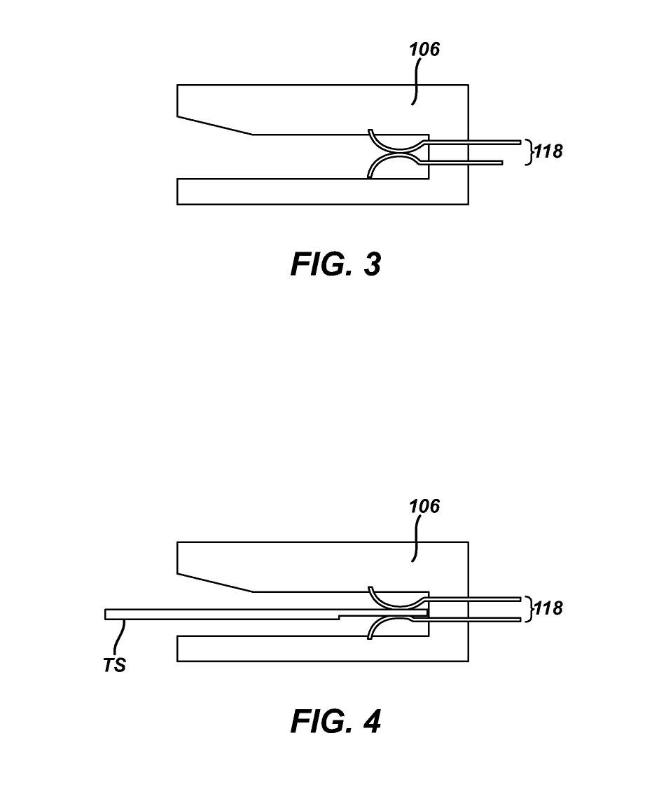

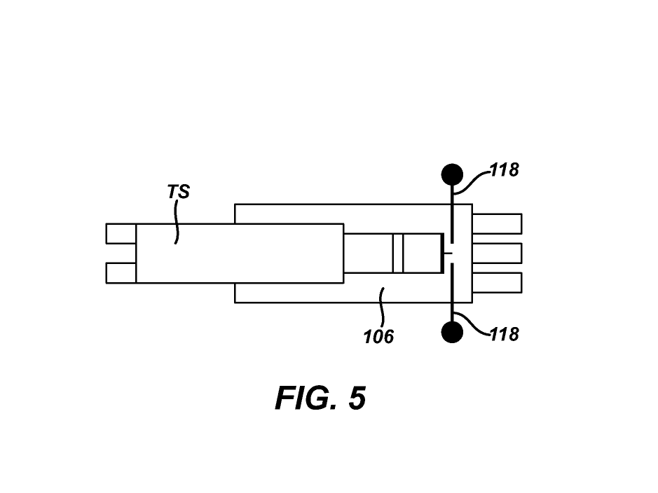

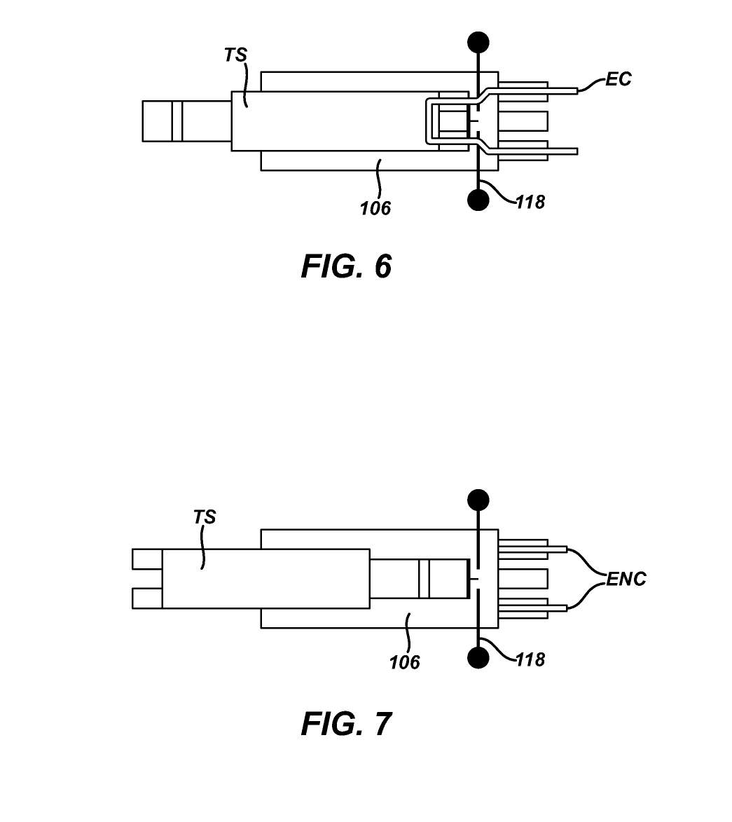

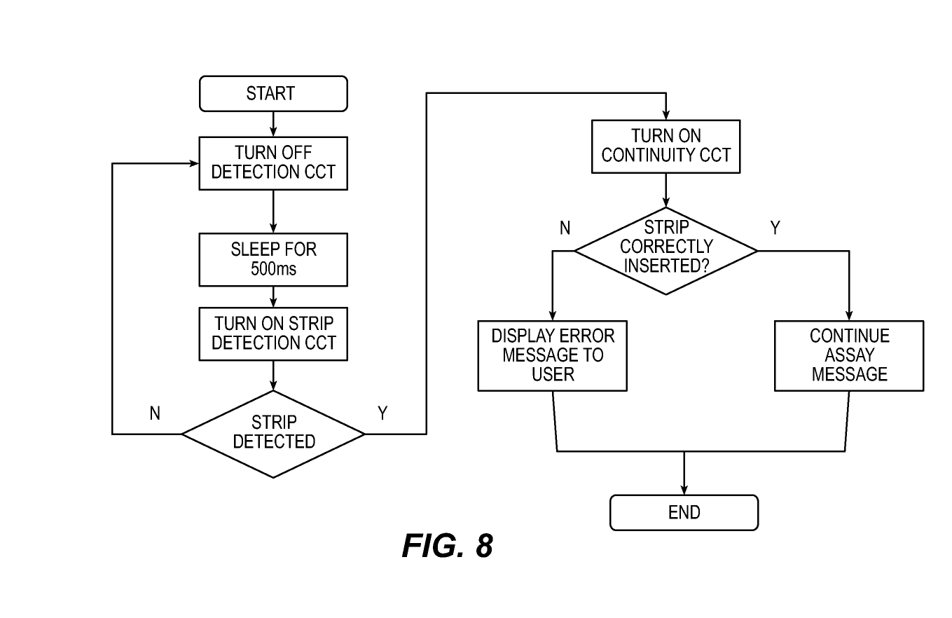

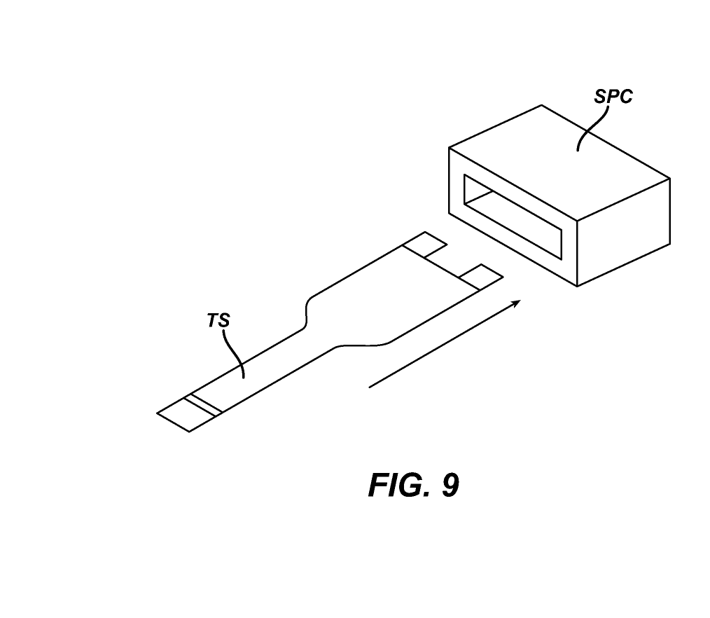

FIG. 1 is a simplified perspective depiction of a hand-held test meter 100 according to an embodiment of the present invention. FIG. 2 is a simplified block diagram of hand-held test meter 100. FIG. 3 is a simplified cross-sectional side-view depiction of the strip port connector (including a test strip insertion detector) of hand-held test meter 100. FIG. 4 is a simplified cross-sectional side-view depiction of the strip port connector (including a test strip insertion detector) of hand-held test meter 100 with an analytical test strip (TS) inserted therein. FIG. 5 is a simplified top cross-sectional block and test strip insertion switch-schematic diagram representing an analytical test strip inserted with an incorrect orientation into the strip port connector of hand-held test meter 100. FIG. 6 is a simplified top cross-sectional block and test strip insertion switch-schematic diagram representing an analytical test strip inserted with a correct orientation into the strip port connector of the hand-held test meter 100 and with a line (EC) indicating electrical continuity through the analytical test strip. FIG. 7 is a simplified top cross-sectional block and test strip insertion switch-schematic diagram representing an analytical test strip inserted with an incorrect orientation into the strip port connector of the hand-held test meter 100 and with a line (ENC) indicating electrical non-continuity (i.e., electrical discontinuity) through the analytical test strip. FIG. 8 is a flow diagram of an example of operation of a hand-held test meter 100.

Referring to FIGS. 1 through 8, hand-held test meter 100 includes a display block 102, a plurality of user interface buttons 104, a strip port connector 106, a USB interface 108, and a housing 110 (see FIG. 1). Referring to FIG. 2 in particular, hand-held test meter 100 also includes a micro-controller 112 disposed in housing 110, a strip detection circuit block 114 (also disposed in housing 110) and a strip continuity circuit block 116 disposed in housing 110. Moreover, strip port connector 106 (also generically referred to as an SPC) includes at least one test strip insertion detector 118.

In addition, hand-held test meter 100 also includes other electronic components (not shown) for applying a test voltage to analytical test strip (labeled TS in, for example FIG. 1), and also for measuring an electrochemical response (e.g., plurality of test current values) and determining an analyte or characteristic based on the electrochemical response. To simplify the current descriptions, the figures do not depict all such electronic circuitry.

Strip continuity circuit block 116 can take any suitable form known to one of skill in the art. Strip continuity circuit block 116 can operate, for example, by attempting to pass a small electrical current (for example, an alternating or direct current in the range of 10 nano-amps to 10 milli-amps) through the electrical contacts of an analytical test strip inserted into the strip port connector. When an analytical test strip has been inserted with an incorrect orientation (see, for example FIG. 7), electrical non-continuity will exist and current will not flow. Such an electrical non-continuity can be signaled to the micro-controller as a predetermined logic state (e.g., either a logical “1” or “0” state). When an analytical test strip has been inserted with a correct orientation (see, for example FIG. 6), electrical continuity will exist and current will flow. Such an electrical continuity can be signaled to the micro-controller as a change in the logic state.

Test strip insertion detector 118 can be any suitable test strip detector known to one skilled in the art including a suitable mechanical-electrical switch (as depicted schematically in FIGS. 5, 6 and 7) and as a pair of normally closed contacts as depicted in FIGS. 3 and 4. In addition, test strip insertion detectors employed in hand-held test meters according to the present invention can be an optical-reflective switch (e.g., an optical-reflective switch commercially available from Omron as part number EESY110), an optically-transmissive switch (such as an optically-transmissive switch commercially available from Omron as part number EESX1105), or a micro-switch such the micro-switch commercially available from Omron as part number D2MQ-1 L, or a pair of normally open contacts. Moreover, the test strip insertion detector and strip detection circuit block can be integrated as a single component.

Referring to FIGS. 2 and 8 in particular, hand-held test meter 100 is configured such that the test strip insertion detector(s) and strip detection circuit block 114 alternate between a powered-on state and 500 ms inactive sleep periods employed to save power. When an analytical test strip is inserted and activates at least one test strip insertion detector, strip detection circuit block 114 sends a “strip detect signal” to micro-controller 112. Micro-controller 112 then enables power for strip continuity circuit block 116 and thereafter interrogates strip continuity circuit block 116 (by receipt of a strip continuity signal) as to whether electrical continuity or electrical non-continuity (i.e., electrical discontinuity) has been detected. If the strip continuity signal indicates a correct orientation of analytical test strip insertion, an appropriate message will be displayed to a user (e.g., a continuing with assay message). However, if the strip continuity signal indicates an incorrect orientation of analytical test strip insertion, an appropriate alert message will be displayed to a user (such as an error message).

Strip detection circuit block 114 and micro-controller 112 are configured to detect the insertion of an analytical test strip into the strip port connector and send an insertion signal (labeled “strip detect signal” in FIG. 2) to the micro-controller upon such detection. Micro-controller 112 is configured to receive the insertion signal from the strip detection circuit block 114 and based on that signal, activate strip continuity circuit block 116, and receive a strip continuity signal from activated strip continuity circuit block 116. Micro-controller 112 is also configured to distinguish an orientation (either a correct orientation or an incorrect orientation) of analytical test strip insertion based on the insertion and strip continuity signals and signal the display module to display a predetermined message to a user based on the distinguished orientation.

Strip continuity circuit block 116 is configured to assess electrical continuity through an analytical test strip inserted in strip port connector 106 and to provide a strip continuity signal to micro-controller 112 based on the assessed continuity.

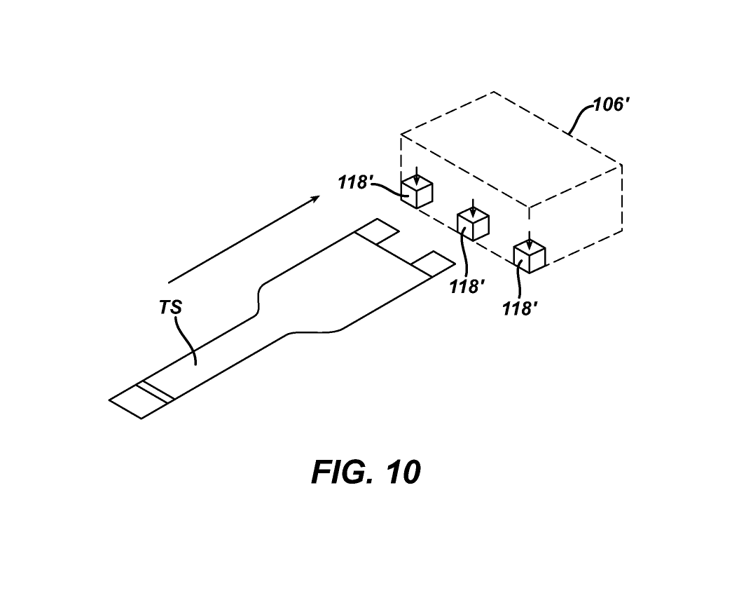

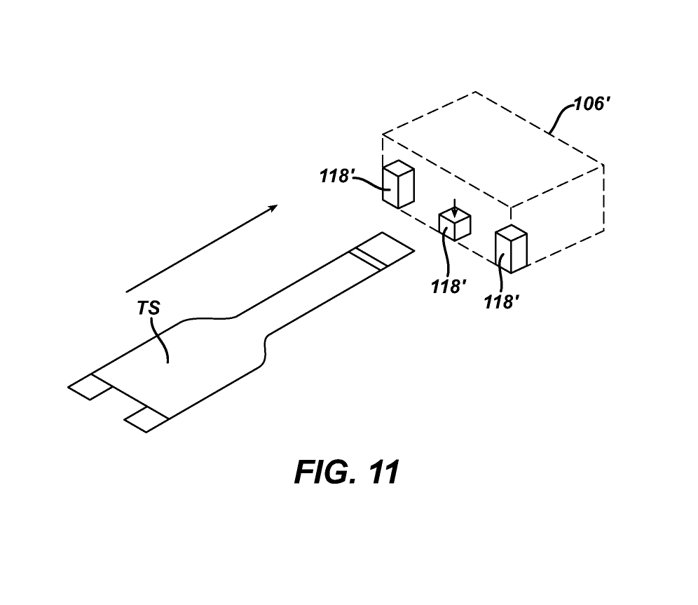

FIG. 9 is a simplified perspective depiction of an analytical test strip TS being inserted into a generic strip port connector (SPC). FIG. 10 is a simplified perspective depiction of an analytical test strip TS being inserted, with a correct orientation, into a strip port connector 106′ with a plurality of test strip insertion detectors 118′ as can be included in another hand-held test meter according to embodiments of the present invention. FIG. 11 is a simplified perspective depiction of an analytical test strip TS being inserted, with an incorrect orientation, into strip port connector 106′. In FIGS. 10 and 11, similar elements to the embodiment of FIGS. 1-8 are given like numerals but with the addition of a prime 0 mark to indicate that they are included in another embodiment of hand-held test meters according to the present invention. The straight arrows alongside the analytical test strips of FIGS. 9, 10 and 11 depict the direction of travel for the analytical test strip as it is being inserted.

The embodiment of FIGS. 10 and 11 includes three test strip insertion detectors 118′. One of the test strip insertion detectors is disposed along a centerline of strip port connector 106′ and the other two test strip insertion detectors are disposed along the lateral sides of strip port connector 106′. The positioning of the three test strip insertion detectors is such that, for the analytical test strip depicted in FIGS. 10 and 11, a wrong end first type of incorrect orientation will activate less than all three test strip insertion detectors.

FIG. 10 depicts an analytical test strip being inserted in a correct orientation that activates all three test strip insertion detectors as indicated by the three downward facing arrows above the test strip insertion detectors. FIG. 11 depicts an analytical test strip being inserted in an incorrect orientation (i.e., a wrong end first orientation) that activates only the test strip insertion detector disposed along the centerline, as indicated by a single downward facing arrow on said test strip insertion detector.

A micro-controller in the hand-held test meter that includes strip port connector 106′ is configured to receive an insertion signal from a strip detection circuit block connected to each of the three of test strip insertion detectors 118′ and to distinguish an orientation of analytical test strip insertion based on the insertion signals received. Activation of less than all of the first, second and third test strip insertion detectors, results in the strip detection circuit block sending an insertion signal indicative of an incorrect orientation of test strip insertion orientation to the micro-controller. Activation of the first, second and third test strip insertion detectors, indicates that the correct end of a analytical test strip has been inserted but cannot, by itself, distinguish a correct orientation from an orientation wherein the correct end has been inserted but wrong-side up. An electrical continuity check can, however, be employed to distinguish between these two orientations where the correct end of the analytical test strip has been inserted.

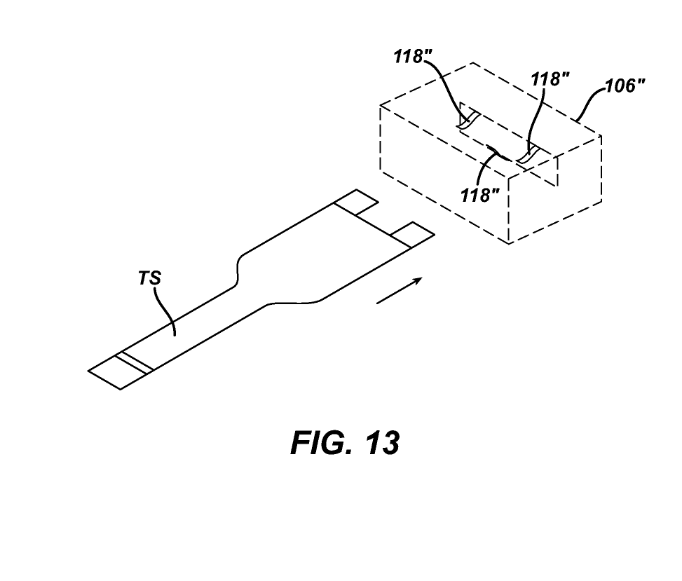

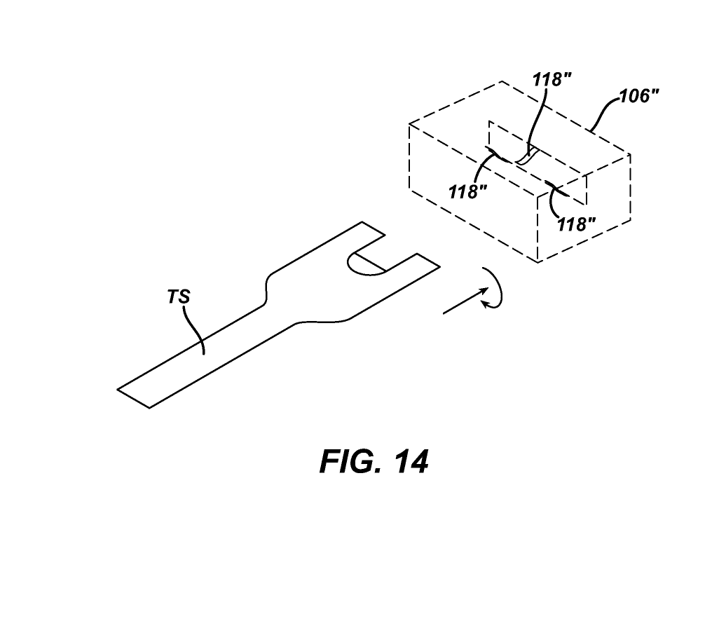

FIGS. 12A and 12B are simplified perspective and end views of a strip port connector 106″ with a plurality of electro-mechanical test strip insertion detectors 118″ that have dual electrical contacts as can be included in hand-held test meters according to embodiments of the present invention. FIG. 13 is simplified perspective depiction of an analytical test strip TS being inserted, with a correct orientation, into strip port connector 106″ but only depicting the electrical contacts that would make electrical contact to the analytical test strip. FIG. 14 is simplified perspective depiction of an analytical test strip being inserted, with an upside-down orientation that is rotated 180 degrees about the longitudinal axis of the analytical test strip, into strip port connector 106″ but only depicting the electrical contacts that would make electrical contact to the analytical test strip. The straight arrows alongside the analytical test strip of FIGS. 13 and 14 depict the direction of travel for the analytical test strip as it is being inserted.

Referring to FIGS. 12A, 12b, 13 and 14, electro-mechanical test strip insertion detectors 118″ are configured as pairs of opposing (mirrored) electrical contacts. FIG. 13 depicts the manner in which a correctly inserted analytical test strip will establish electrical connection with three of the opposing contacts. The activation of these three contacts by the establishment of an electrical contact results in an insertion signal indicating correct test strip orientation.

FIG. 14 depicts an analytical test strip that has been inserted “wrong” side up (i.e., in a simple upside-down orientation). In this circumstance, electrical contact is established with three different electrical contacts (compare FIGS. 13 and 14). The activation of these three contacts by the establishment of an electrical connection results in an insertion signal indicating a simple upside down orientation of analytical test strip insertion. A micro-controller of the hand-held test meter can then either consider this an incorrect orientation or considers it a correct orientation as long as analyte determination proceeds in a manner appropriate for the electrical contacts that has been established. In other words, for such a simple upside down configuration, the micro-controller can configure the electrical connections to the analytical test strip such that the determination can proceed thus rendering the simple upside down orientation a correct orientation.

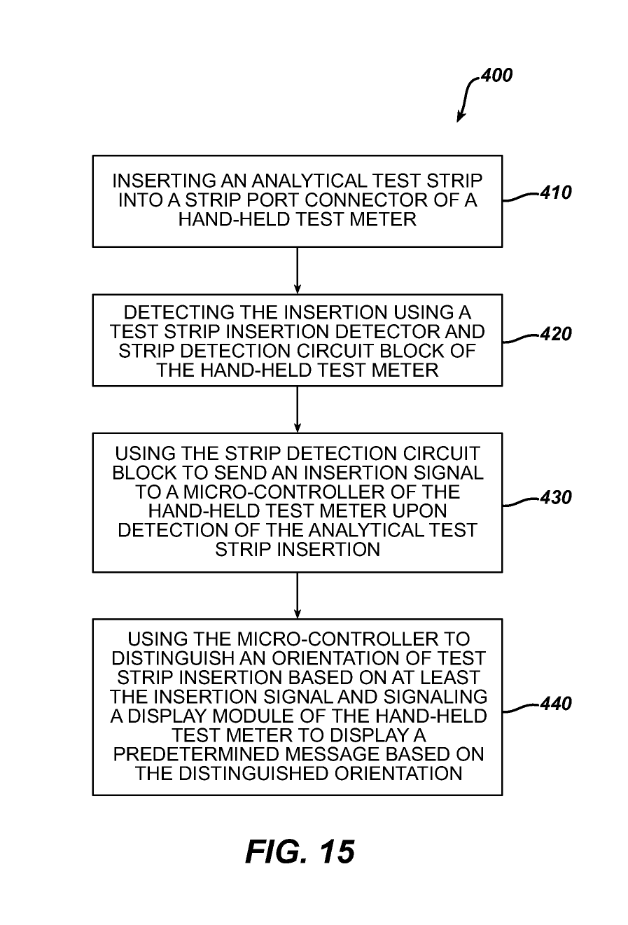

FIG. 15 is a flow diagram depicting stages in a method 400 for employing a hand-held test meter according to an embodiment of the present invention. Method 400 includes inserting an analytical test strip into a strip port connector of a hand-held test meter (see step 410 of FIG. 15).

At step 420, the insertion of the analytical test strip is detected using at least one test strip insertion detector of the strip port connector and a strip detection circuit block of the hand-held test meter. The strip detection circuit block is used to send an insertion signal to a micro-controller of the hand-held test meter upon detection of analytical test strip insertion into the strip port connector (see step 430 of method 400).

The micro-controller distinguishes an orientation of test strip insertion (e.g., a correct orientation or an incorrect orientation) based on at least the insertion signal and signals a display module of the hand-held test meter to display a predetermined message to a user based on the distinguished orientation (see step 440). The predetermined message can be, for example, an error alert message indicating incorrect orientation and instructions on how to insert the analytical test strip correctly or a message indicating the analyte determination is continuing (i.e., the “assay” of the analyte continues). The use of such messages based on determining whether a test strip has been inserted with a correct orientation or an incorrect orientation is also depicted in FIG. 8.

Once apprised of the present disclosure, one skilled in the art will recognize that methods according to embodiments of the present invention, including method 400, can be readily modified to incorporate suitable techniques, features, benefits, capabilities and characteristics of hand-held test meters to embodiments of the present invention and described herein including, for example, the hand-held test meters of FIGS. 1 through 7 and associated operational flow depicted in FIG. 8.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

What is claimed is:

1. A hand-held test meter for use with an analytical test strip in the determination of an analyte in a bodily fluid sample, the hand-held test meter comprising:
a housing;
a display block;
a micro-controller disposed in the housing;
a strip detection circuit block disposed in the housing; and
a strip port connector with:
at least one test strip insertion detector,
wherein the at least one test strip insertion detector and strip detection circuit block are configured to detect the insertion of an analytical test strip into the strip port connector and send an insertion signal to the micro-controller upon such detection; and
wherein the micro-controller is configured to receive the insertion signal, distinguish an orientation of analytical test strip insertion based on at least the insertion signal and signal the display module to display a predetermined message to a user based on the distinguished orientation of analytical test strip insertion.

2. The hand-held test meter of claim 1 further including:
a strip continuity circuit block disposed in the housing, the strip continuity circuit block configured to assess electrical continuity through an analytical test strip inserted in the strip port connector, and
wherein the micro-controller and strip continuity circuit are configured such that upon receipt of an insertion signal by the micro-controller, the micro-controller and enables the strip continuity circuit block to assess electrical continuity through an analytical test strip inserted into the strip port connector and to provide a strip continuity signal to the micro-controller based on the assessed continuity, and
wherein the wherein the micro-controller distinguishes an orientation of analytical test strip insertion based on a combination of the insertion signal and strip continuity signal.

3. The hand-held test meter of claim 2 wherein the at least one test strip insertion detector is a single test strip insertion detector.

4. The hand-held test meter of claim 2 wherein the strip detection circuit and micro-controller are further configured such that detection of analytical test strip insertion by the at least one test strip detector initiates a power activation of the strip continuity circuit block.

5. The hand-held test meter of claim 2 wherein the sensing of electrical continuity by strip continuity circuit block indicates that the analytical test strip is inserted in a correct orientation and the sensing of electrical discontinuity indicates that the analytical test strip is inserted in an incorrect orientation.

6. The hand-held test meter of claim 1 wherein the at least one test strip insertion detector is a plurality of test strip insertion detectors.

7. The hand-held test meter of claim 6 wherein the plurality of test strip insertion detectors includes a first test strip insertion detector, a second test strip insertion detector and a third analytical test strip detector, and
wherein activation of at least one but less than three of the first test strip insertion detector, second test strip insertion detector and third test strip insertion detector, results in the strip detection circuit block sending an insertion signal indicative of incorrect orientation of analytical test strip insertion to the micro-controller.

8. The hand-held test meter of claim 1 wherein test strip detector is an electro-mechanical switch.

9. The hand-held test meter of claim 1 wherein the test strip detector is an optical-reflective sensor.

10. The hand-held test meter of claim 1 wherein the test strip detector is an optical-transmissive sensor.

11. A method for employing a hand-held test meter, the method comprising:
inserting an analytical test strip into a strip port connector of a hand-held test meter;
detecting the insertion using at least one test strip insertion detector of the strip port connector and a strip detection circuit block of the hand-held test meter;
sending, using the strip detection circuit block, an insertion signal to a micro-controller of the hand-held test meter upon detection of analytical test strip insertion into the strip port connector;
distinguishing, using the micro-controller, an orientation of analytical test strip insertion based on at least the insertion signal and signaling the display module to display a predetermined message to a user based on the distinguished orientation of analytical test strip insertion.

12. The method of claim 11 further including:
determining, based on having distinguished a correct orientation of analytical test strip insertion, an analyte in a bodily fluid sample applied to the test strip.

13. The method of claim 12 wherein the analyte is glucose and the bodily fluid sample is a whole blood sample.

14. The method of claim 11 wherein the distinguishing step is based on the insertion signal and a strip continuity signal provided by a strip continuity circuit block of the hand-held test meter.

15. The hand-held test meter of claim 14 wherein the at least one test strip insertion detector is a single test strip insertion detector.

16. The method of claim 14 wherein the strip detection circuit and micro-controller are further configured such that detection of analytical test strip insertion by the at least one test strip detector initiates a power activation of the strip continuity circuit block.

17. The method of claim 14 wherein the sensing of electrical continuity by the strip continuity circuit block indicates that the analytical test strip is inserted in a correct orientation and the sensing of electrical discontinuity indicates that the analytical test strip is inserted in an incorrect orientation.

18. The method of claim 11 wherein the at least one test strip insertion detector is a plurality of test strip detectors.

19. The method of claim 18 wherein the plurality of test strip detectors includes a first test strip insertion detector, a second test strip insertion detector and a third analytical test strip detector, and
wherein activation of at least one but less than three of the first test strip insertion detector, second test strip insertion detector and third test strip insertion detector, results in the strip detection circuit block sending an insertion signal indicative of incorrect orientation of analytical test strip insertion orientation to the micro-controller.

20. The method claim 11 wherein test strip detector is an electro-mechanical switch.

21. The method of claim 11 wherein the test strip detector is an optical-reflective sensor.

22. The method of claim 11 wherein the test strip detector is an optical-transmissive sensor.
